(19) United States
(12) Patent Application Publication
(10) Pub. No.: US 2010/0123561 A1
(43) Pub. Date: May 20, 2010

(54) Radio frequency identification apparatus with a plurality of radio frequency identification schemes

(75) Inventors: Kuang Woo Nam, Suwon-si (KR); Younghoon Min, Anyang-si (KR)

Correspondence Address: HARNESS, DICKEY & PIERCE, P.L.C., P.O. BOX 8910, RESTON, VA, 20195, US

(73) Assignee: Samsung Electronics Co., Ltd.

(21) Appl. No.: 12/585,729

(22) Filed: Sep. 23, 2009

(30) Foreign Application Priority Data
Nov. 19, 2008 (KR) 10-2008-0115200

(51) Int. Cl. H04Q 5/22

(52) U.S. Cl. 340/10.5

(57) ABSTRACT

Disclosed is a radio frequency identification (RFID) apparatus which includes a first RFID chip for controlling data communication in a first RFID scheme, a second RFID chip for controlling data communication in a second RFID scheme, a loop antenna having first antenna connection terminals for forming a first length and second antenna connection terminals for forming a second length, a switch circuit connected with the first and second antenna connection terminals of the loop antenna and the first RFID chip and the second RFID chip and a controller for controlling the switch circuit so as to selectively switch the loop antenna into one of the first RFID chip and the second RFID chip based on whether data communication is one of the first and second RFID schemes.

### PRIORITY STATEMENT

This U.S. non-provisional patent application claims priority under 35 U.S.C. §119 to Korean Patent Application No. 10-2008-0115200 filed on Nov. 19, 2008, in the Korean Intellectual Property Office (KIPO), the entire contents of which is hereby incorporated by reference.

### BACKGROUND

1. Field

Example embodiments relate to a Radio Frequency Identification (RFID) system. More particularly, example embodiments relate to an RFID apparatus with a plurality of RFID schemes.

2. Description of the Related Art

In general, an RFID system is a system which recognizes information recorded in a tag via a wireless communication. The recorded information belongs to RFID fields for example a barcode label, a magnetic stripe, etc. An RFID reader receives information stored in the tag via an antenna. The RFID reader recognizes and analyzes the received information, and obtains inherent and circumstance information for a product where the tag is applied or, incorporated.

The RFID system includes for example a reader, an antenna, a tag, etc. The antenna performs an intermediation function between the tag and the reader. A power and a signal are sent to the tag via the antenna via a wireless communication, so that the tag is activated. Further, a response from the tag is received via the antenna.

The RFID system uses a Near Field Communication (NFC) scheme and a mobile RFID (mRFID) scheme.

The RFID system of the NFC scheme, for example, uses a frequency (e.g., 13.56 MHz) of a high frequency band to transmit data at a distance between 10 cm and 60 cm. Since the NFC scheme provides high security, the NFC scheme has been used in applications for example a traffic card, mobile payment, etc.

The RFID system of the mRFID scheme, for example, uses a frequency (e.g., 900 MHz) of a ultra high frequency band to transmit data at a distance within 10 m. The mRFID scheme has such advantages that an identification distance is far and the performance is excellent. For these reasons, the mRFID scheme has been used in applications for example harbor container, remote inspection, tire pressure monitoring system (TPMS), distribution logistics, etc.

The NFC scheme and the mRFID scheme include used frequencies and applied fields that are different from each other. Hardware configurations of the NFC and mRFID schemes are similar to each other. Integration of the above-described RFID schemes in one RFID apparatus (including a reader and an antenna), that is, a mobile terminal such as cellular phone, personal digital assistant, portable multimedia player, etc., in order to improve the efficiency of a hardware application.

### SUMMARY

Example embodiments provide an RFID apparatus capable of communicating data via a plurality of RFID schemes.

The example embodiments provide a radio frequency identification (RFID) apparatus including a first RFID chip configured to control data communication using a first RFID scheme, a second RFID chip configured to control data communication using a second RFID scheme and a loop antenna having first antenna connection terminals for a first length and second antenna connection terminals for a second length. The RFID apparatus further includes a switch circuit connected with the first and second antenna connection terminals of the loop antenna, the first RFID chip and the second RFID chip and a controller configured to control the switch circuit so as to selectively switch the loop antenna into one of the first RFID chip and the second RFID chip based on whether data communication is one of the first and second RFID schemes.

The example embodiments provide a radio frequency identification (RFID) apparatus including two or more RFID chips configured to control data communication using two or more RFID schemes, an antenna having two or more antenna connection terminals and having two or more loop lengths, a switch configured to switch the two or more RFID chips between the two or more antenna connection terminals and a controller configured to determine a selected RFID scheme, and to control the switch based on the selected RFID scheme.

The example embodiments provide a method for operating a radio frequency identification (RFID) device with two or more RFID chips, the method including determining if a select signal has been detected, determining if the select signal selects a first RFID scheme if the select signal has been detected, switching an antenna, having first antenna connection terminals for a first length and second antenna connection terminals for a second length, such that the first antenna connection terminals and a first RFID chip are selected if the first RFID scheme is selected, the first RFID chip configured to perform the first RFID scheme and switching the antenna such that the second antenna connection terminals and a second RFID chip of the RFID chips are selected to receive the data communications if the first chip is not selected, the second RFID chip configured to perform a second RFID scheme.

### BRIEF DESCRIPTION OF THE FIGURES

Example embodiments will be more clearly understood from the following brief description taken in conjunction with the accompanying drawings. FIGS. 1-9 represent non-limiting, example embodiments as described herein.

FIG. 1 is a diagram showing an antenna structure of an RFID apparatus adopting an NFC manner according to the example embodiment.

FIG. 2 is a diagram showing an antenna structure of an RFID apparatus adopting an mRFID manner according to the example embodiment.

FIG. 3 is a block diagram showing an RFID apparatus according to the example embodiment.

FIG. 4 is a circuit diagram showing a resonance circuit according to adoption of an NFC manner.

FIG. 5 is a diagram showing an antenna structure according to the example embodiment.

FIG. 6 is a diagram showing a switch structure according to the example embodiment.

FIG. 7 is a diagram showing a switch structure according to another example embodiment.

FIG. 8 is a diagram showing a switch structure according to still other example embodiment.

FIG. 9 is a flowchart for describing an operation of an RFID apparatus according to the example embodiment.

It should be noted that these Figures are intended to illustrate the general characteristics of methods, structure and/or materials utilized in certain example embodiments and to supplement the written description provided below. These drawings are not, however, to scale and may not precisely reflect the precise structural or performance characteristics of any given embodiment, and should not be interpreted as defining or limiting the range of values or properties encompassed by example embodiments. For example, the relative thicknesses and positioning of molecules, layers, regions and/or structural elements may be reduced or exaggerated for clarity. The use of similar or identical reference numbers in the various drawings is intended to indicate the presence of a similar or identical element or feature.

### DETAILED DESCRIPTION OF THE EMBODIMENTS

Example embodiments will now be described more fully with reference to the accompanying drawings, in which example embodiments are shown. Example embodiments may, however, be embodied in many different forms and should not be construed as being limited to the embodiments set forth herein; rather, these embodiments are provided so that this disclosure will be thorough and complete, and will fully convey the concept of example embodiments to those of ordinary skill in the art. In the drawings, the thicknesses of layers and regions are exaggerated for clarity. Like reference numerals in the drawings denote like elements, and thus their description will be omitted.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Like numbers indicate like elements throughout. As used herein the term “and/or” includes any and all combinations of one or more of the associated listed items.

It will be understood that, although the terms “first”, “second”, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of example embodiments.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Example embodiments are described herein with reference to cross-sectional illustrations that are schematic illustrations of idealized embodiments (and intermediate structures) of example embodiments. As such, variations from the shapes of the illustrations as a result, for example, of manufacturing techniques and/or tolerances, are to be expected. Thus, example embodiments should not be construed as limited to the particular shapes of regions illustrated herein but are to include deviations in shapes that result, for example, from manufacturing. For example, an implanted region illustrated as a rectangle may have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of example embodiments.

Unless otherwise defined, all terms (including technical and scientific terms) used herein have the same meaning as commonly understood by one of ordinary skill in the art to which example embodiments belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

An RFID system may include an RFID apparatus which uses a plurality of RFID schemes. In particular, the RFID apparatus is configured to use an NFC manner and an mRFID schemes.

The example embodiment will be described using an example where the NFC scheme using a high frequency band and the mRFID scheme using an ultra high frequency band are applied. Example embodiments may be applied to RFID schemes using at least two bands of a low frequency band, a high frequency band, an ultra high frequency band, and a microwave band.

The low frequency band may be between 30 kHz and 300 kHz (a frequency of Industrial Scientific Medical (ISM) band, below 135 kHz), the high frequency band may be between 3 MHz and 30 MHz (ISM frequency, 6.78 MHz, 13.56 MHz, 27.125 MHz, and 40.68 MHz), the ultra high frequency band may be between 300 MHz and 3 GHz (ISM frequency, 433.92 MHz, 869 MHz, and 915 MHz), and the microwave band may be over 3 GHz (ISM frequency, 2.45 GHz, 5.8 GHz, and 24.125 GHz).

A frequency of 13.56 MHz may be used at the NFC scheme and a frequency of 900 MHz may be used at the mRFID scheme.

The RFID apparatus of the example embodiment may be configured to include a reader and an antenna among constituent elements of the RFID system.

In the RFID apparatus, integrating antennas for performing an intermediation role between a tag and a reader may be required in order to integrate the NFC scheme and the mRFID scheme. A loop antenna is used as an antenna for supporting the NFC and mRFID schemes.

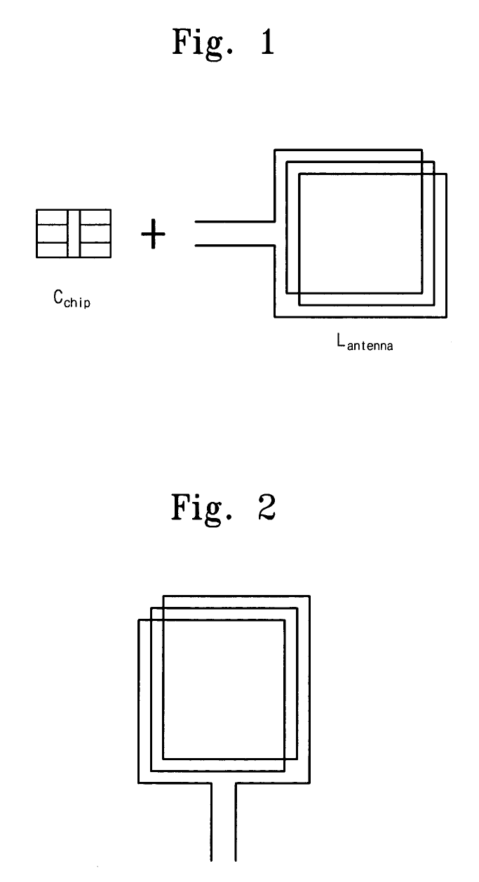

FIG. 1 is a diagram showing an antenna structure of an RFID apparatus adopting an NFC scheme according to the example embodiment.

Referring to FIG. 1, a loop antenna may be used for data communication in the NFC scheme. In the NFC scheme, the loop antenna has an inductance value Lₐₙₜₑₙₙₐ and determines a frequency for data communication via resonance (e.g., LC resonance) with a capacitance value C_{chip} of a chip. An operating frequency of the NFC scheme may be expressed as the following equation 1.

fᵣ=½π\sqrt{LₐₙₜₑₙₙₐC_{chip}}

In equation 1, the symbol fᵣ is a frequency of the NFC band, the symbol C_{chip} is a capacitance value, and Lₐₙₜₑₙₙₐ is an inductance value. The inductance value Lₐₙₜₑₙₙₐ may be determined according to a length of an antenna, and the capacitance value C_{chip} may be determined by an inductance value Lₐₙₜₑₙₙₐ which may be dependent on an antenna having a given length.

If an antenna has a length of about 10 cm, In this case, the loop antenna may have an inductance value of 3 uH. Since a frequency of the NFC band is 13.56 MHz, the capacitance value C_{chip} is determined to be 50 pF.

If the RFID apparatus adopting the NFC scheme, since a capacitance value of a chip may be determined according to a length of a loop antenna, using loop antennas with various lengths may be possible. Further, adopting the NFC scheme by inserting a loop antenna in a small-sized RFID apparatus such as a mobile terminal may be possible.

FIG. 2 is a diagram showing an antenna structure of an RFID apparatus adopting an mRFID scheme according to the example embodiment.

Referring to FIG. 2, a loop antenna may be able to be used for data communication in the mRFID scheme. A length and/or a structure of the loop antenna may be determined according to a frequency used in the mRFID scheme. The length of the antenna may be expressed as the following equation 2.

I=λ/4

In the equation 2, a symbol ‘I’ indicates a length of a loop antenna, and a symbol ‘λ’ indicates an antenna length constant (for example, 30 cm at 1 GHz) determined according to each frequency band. A loop antenna used in the mRFID manner of 900 MHz has a length of about 7 cm.

The above description may show that the NFC scheme and the mRFID scheme may be integrated by controlling a length of a loop antenna applied to the RFID apparatus. Therefore, a length of the loop antenna may be determined to support both the NFC scheme and the mRFID scheme at the resonance frequency.

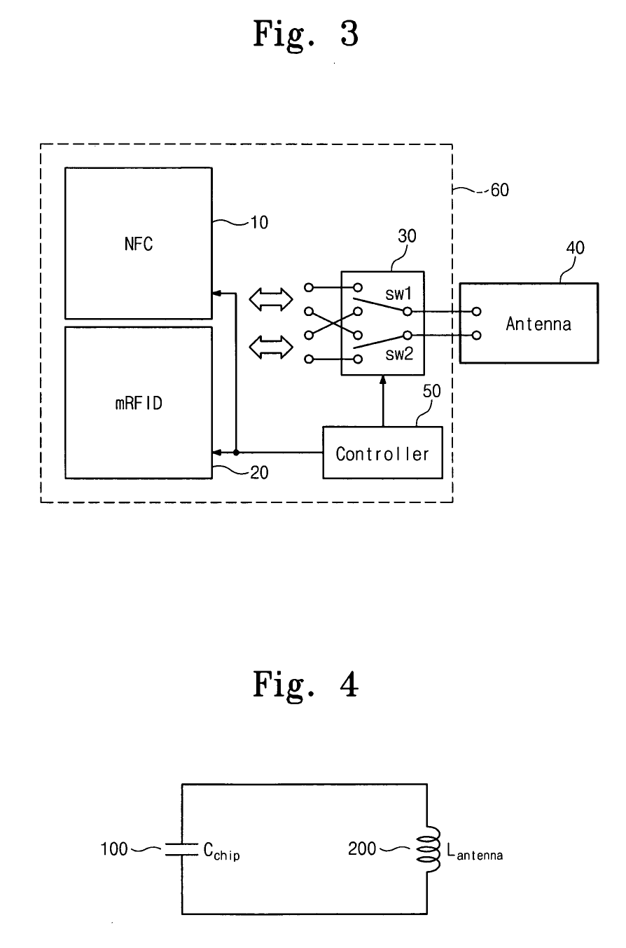

FIG. 3 is a block diagram showing an RFID apparatus according to the example embodiment.

Referring to FIG. 3, an RFID apparatus 60 includes an NFC chip 10, an mRFIC chip 20, a switch circuit 30, a controller 50, and an antenna 40.

The NFC chip 10 is a chip which may be configured to conduct data communication in the NFC scheme. The NFC chip 10 may be configured to include at least a capacitor having a given/adjustable capacitance value which may be used for the LC resonance with an inductance value made by the antenna 40.

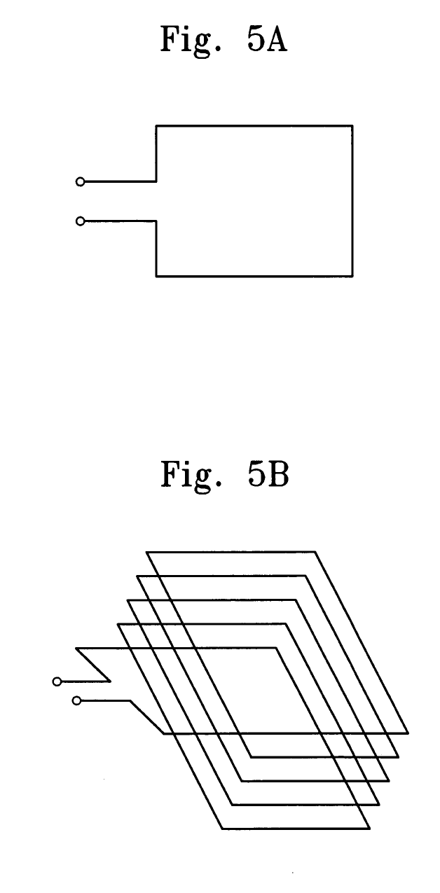

The antenna 40 may be, for example, a loop antenna, having a length suitable for supporting two RFID schemes, for example, the NFC scheme and the mRFID scheme. In other words, the loop antenna may have a length suitable for supporting a frequency band of the NFC scheme and a frequency band of the mRFID scheme at a resonance frequency. A structure of a usable loop antenna will be more fully described with reference to FIG. 5.

The loop antenna 40 may have the first antenna connection terminals for the first length and the second antenna connection terminals for the second length. The first length is identical to or different from the second length. If the first length is identical to the second length, each of the first and second lengths may be suitable for supporting the two RFID schemes.

If the first length is different from the second length, since the NFC scheme needs a loop antenna having a longer length than that of the mRFID scheme, one of the first and second lengths has a longer length than the other. The first antenna connection terminals are connected to the NFC chip 10, and the first length has a longer length than the second length.

The controller 50 may be configured to determine the use of one of the NFC scheme and the mRFID scheme. For example, the controller 50 may receive a selection signal from a user via an input part (not shown) to control the switch circuit 30 in response to the received selection signal.

The controller 50 may be configured to control the switch circuit 30, having switches sw1 and sw2, and the chips 10 and 20 which may be individual modules. The controller 50 may be included in any one of the chips 10 and 20 or in each of the chips 10 and 20.

The switch circuit 30 may connect terminals of the antenna 40 to the NFC chip 10 or the mRFID chip 20 in response to a control of the controller 50. The switch circuit 30 may conduct a switching operation according to a control signal generated from the controller 50. The switch circuit 30 may connect the terminals of the antenna 40 to the NFC chip 10 when data communication is conducted in the NFC scheme and to the mRFID chip 20 when data communication is conducted in the mRFID scheme.

If the select signal is not received (detected), the data communication may be in a default manner under the control of the controller 50. In other words, at an initial stage of the data communication, the terminals of the antenna 40 may be connected to any one of the NFC and mRFID chips 10 and 20. This means that the data communication may be at an initial/default connection state between the antenna 40 and an NFC/mRFID chip when no select signal is received.

If the NFC chip 10 and the mRFID chip 20 are individual modules, the switch circuit 30 may be an individual module. The switch circuit 30 may be implemented by a single chip 60 together with the NFC chip 10 and the mRFID chip 20. In this case, the single chip 60 may include the controller 50.

FIG. 4 shows a resonance circuit when the NFC scheme is adopted.

Referring to FIG. 4, the resonance circuit may include a capacitor 100 and an inductor 200. The inductor 200 may have an inductance value Lₐₙₜₑₙₙₐ determined by a loop antenna which may have a given length. The capacitor 100 may have a capacitance value C_{chip} enabling an LC resonance according to the inductance value.

The illustrated resonance circuit may include the inductor 200 having an inductance value Lₐₙₜₑₙₙₐ of an antenna and the capacitor 100 having a capacitance value C_{chip} of the NFC chip 10. Since the capacitance value of the NFC chip 10 may be variable, a length of a loop antenna so as to have an appropriate length may be determined.

FIGS. 5A and 5B are diagrams showing an antenna structure according to the example embodiment. In FIGS. 5A and 5B, there are illustrated loop antennas which may be formed by winding a wire in a rectangle shape. FIG. 5A illustrates a single turn loop antenna with a single layer structure, and FIG. 5B illustrates a multi turn loop antenna with a multiple layer structure. The multi turn loop antenna makes the winding number be increased.

As illustrated in FIGS. 5A and 5B, the loop antenna may be formed to have a single layer structure or a multiple layer structure. A shape where a wire is wound may be changed variously. For example, the loop antenna may be formed by winding a wire in various shapes such as a regular square shape, a rectangle shape, a triangle shape, a circle shape, etc.

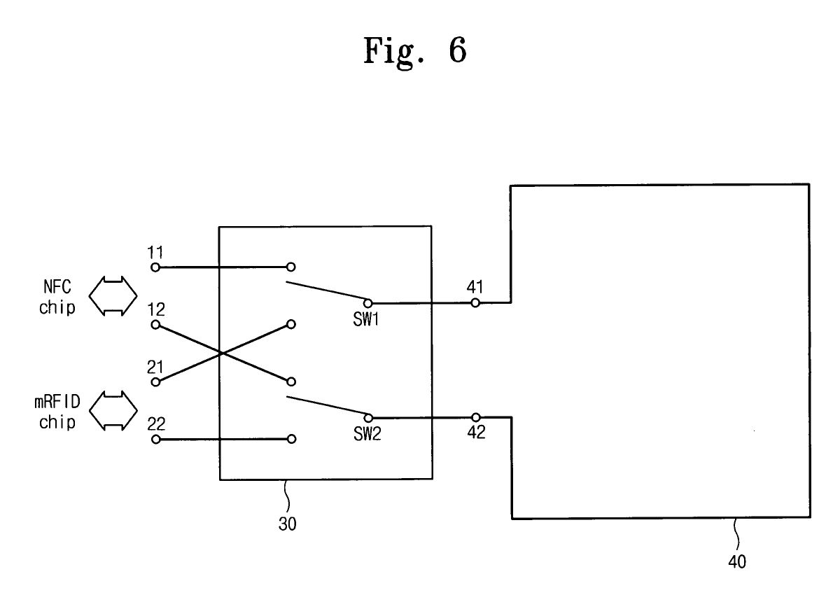

FIG. 6 is a diagram showing a switch structure according to the example embodiment.

Referring to FIG. 6, illustrated is an antenna 40, for example, a loop antenna may have two terminals 41 and 42. A switch circuit 30 may be configured to switch two terminals 41 and 42 connected with the antenna 40 into four terminals 11, 12, 21, and 22 connected with NFC and mRFID chips.

The switch circuit 30 may include the first switch SW1 and the second switch SW2. The antenna 40 may have the first antenna terminal 41 and the second antenna terminal 42, the NFC chip may have the first NFC chip terminal 11 and the second NFC chip terminal 12, and the mRFID chip may have the first mRFID chip terminal 21 and the second mRFID chip terminal 22.

The first switch SW1 may connect the first antenna terminal 41 to the first NFC chip terminal 11 or the first mRFID chip terminal 21 according to an adopted/selected RFID scheme, that is, the NFC scheme or the mRFID scheme. The second switch SW2 connects the second antenna terminal 42 to the second NFC chip terminal 12 or the second mRFID chip terminal 22 according to an adopted/selected RFID scheme, that is, the NFC scheme or the mRFID scheme.

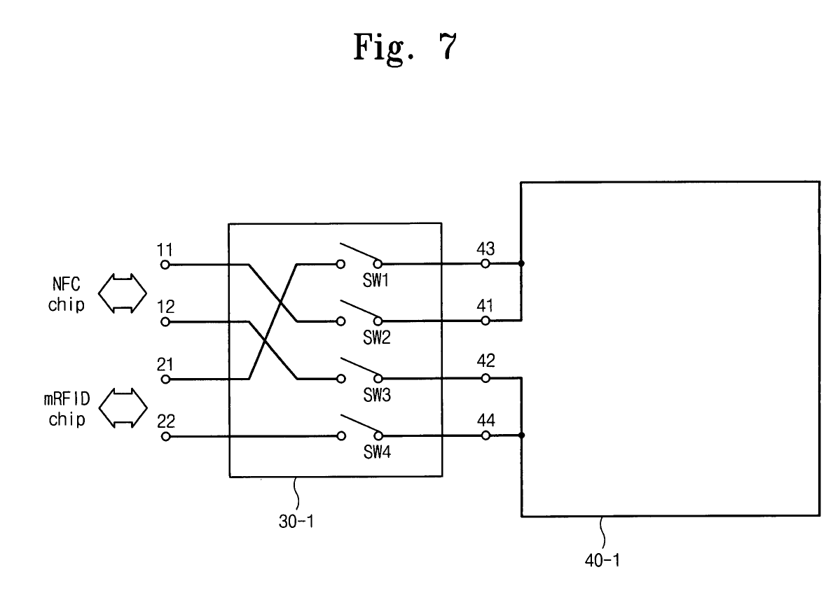

FIG. 7 is a diagram showing a switch structure according to an example embodiment.

Referring to FIG. 7, illustrated is an antenna 40-1, that is, a loop antenna may have four terminals 41, 42, 43, and 44. A switch circuit 30-1 may be configured to switch the four terminals 41 to 44 connected with the antenna 40-1 into four terminals 11, 12, 21, and 22 connected with NFC and mRFID chips.

The switch circuit 30-1 may include the first switch SW1, the second switch SW2, the third switch SW3, and the fourth switch SW4. The antenna 40-1 may include the first and second antenna terminals 41 and 42 for the first length and the third and fourth antenna terminals 43 and 44 for the second length. The NFC chip has the first NFC chip terminal 11 and the second NFC chip terminal 12, and the mRFID chip has the first mRFID chip terminal 21 and the second mRFID chip terminal 22.

The second and third switches SW2 and SW3 may connect the first and second antenna terminals 41 and 42 to the first and second NFC chip terminals 11 and 12, respectively, according to an applied/selected RFID scheme, that is, the NFC or mRFID scheme. The first and fourth switches SW1 and SW4 may connect the third and fourth antenna terminals 43 and 44 to the first and second mRFID chip terminals 21 and 22, respectively, according to an applied/selected RFID scheme, that is, the NFC or mRFID scheme. That is, the second and third switches SW2 and SW3 may form a switch pair, and the first and fourth switches SW1 and SW4 may form a switch pair. Thus, the antenna 40-1 may be connected to the NFC or mRFID chip via one of the switch pairs according to the applied/selected RFID scheme.

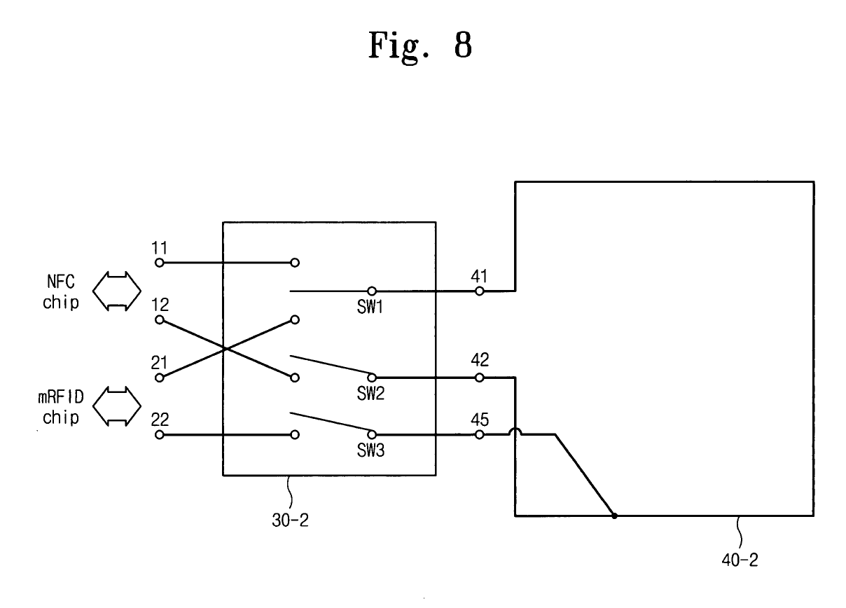

FIG. 8 is a diagram showing a switch structure according to an example embodiment.

Referring to FIG. 8, illustrated is an antenna 40-2, that is, a loop antenna may have three terminals 41, 42, and 45. A switch circuit 30-2 may be configured to switch the three terminals 41, 42, and 45 connected with the antenna 40-2 into four terminals 11, 12, 21, and 22 connected with NFC and mRFID chips.

A switch 30-2 may include the first to third switches SW1, SW2, and SW3. The antenna 40-2 may have the first to third antenna terminals 41, 42, and 45. The first and second antenna terminals 41 and 42 may be used to form the first length, and the first and third antenna terminals 41 and 45 are used to form the second length. The NFC chip may have the first NFC chip terminal 11 and the second NFC chip terminal 12, and the mRFID chip may have the first mRFID chip terminal 21 and the second mRFID chip terminal 22.

The first and second switches SW1 and SW2 may connect the first and second antenna terminals 41 and 42 to the first and second NFC chip terminals 11 and 12, respectively, according to an applied/selected RFID scheme, that is, the NFC or mRFID scheme. The second and third switches SW2 and SW3 may connect the second and third antenna terminals 42 and 45 to the first and second mRFID chip terminals 21 and 22, respectively, according to an applied/selected RFID scheme, that is, the NFC or mRFID scheme. That is, the second switch SW2 may be used to form a switch pair together with the first switch SW1 or with the third switch SW3. Thus, the antenna 40-1 may be connected to the NFC or mRFID chip via a switch pair, which may be SW1 and SW2 or SW2 and SW3, according to the applied/selected RFID schemer.

In accordance with the switch structures in FIGS. 7 and 8, one loop antenna may have two lengths. If an antenna length described in FIGS. 1 and 2 is used, for example, data communication may be in the NFC scheme (about 10 cm) using a loop antenna with a relatively longer length as compared with the mRFID manner (about 7 cm).

As described above, if one loop antenna is set to have two lengths, hardware using an antenna length suitable for each RFID scheme may be more easily configured.

In FIGS. 6 to 8, the example embodiments are described using an example where a single turn loop antenna is applied. A multi turn loop antenna may also be applied to the example embodiment.

An antenna length according to an RFID scheme may be adjusted by further providing at least one connection terminal to a loop antenna which has two connection terminals.

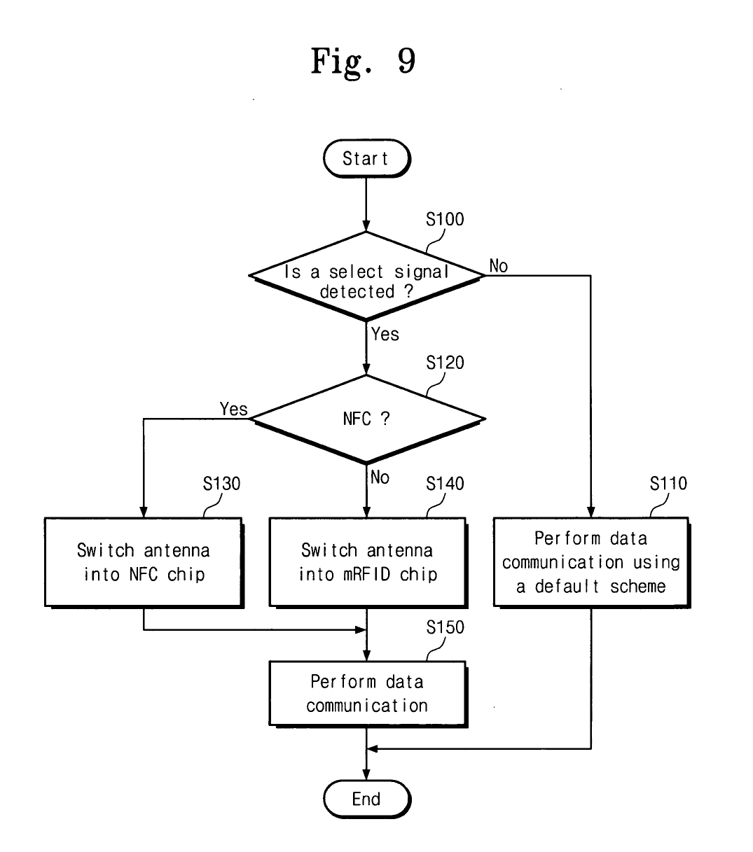

FIG. 9 is a flowchart for describing an operation of an RFID apparatus according to the example embodiment.

Referring to FIG. 9, in step S100, the RFID apparatus, for example, a controller 50 may determine whether a select signal is received. The select signal may be provided by a user to select either one of a plurality of RFID schemes, for example, the NFC scheme and the mRFID scheme. If the select signal is not received, the procedure moves to step S110. In step S110, data communication may be communicated via a default scheme, for example, the NFC scheme or the mRFID scheme, under the control of the controller 50. After data communication is completed via the default scheme, the procedure ends.

If, in step S100, the select signal is detected, in step S120, the controller 50 may determine whether the received select signal indicates that data communication is made in the NFC scheme. If so, the procedure goes to step S130, where a switch circuit 30 connects a loop antenna 40 to an NFC chip 10 under the control of the controller 50. The procedure moves to step S150.

If, in step S120, the received select signal does not indicate that data communication is communicated in the NFC scheme, the procedure moves to step S140. In step S140, the switch circuit 30 connects the loop antenna 40 to an mRFID chip 20 under the control of the controller 50. The procedure moves to step S150. In step S150, the data communication may be communicator via a chip, for example, the NFC chip 10 or the mRFID chip 20 in the RFID apparatus, connected with the loop antenna. When data communication is completed via the selected scheme by the select signal, the procedure ends.

In accordance with the RFID apparatus, when a plurality of RFID schemes are used in the RFID apparatus, preventing additional antennas from being used may be possible via sharing of one loop antenna. Further, the RFID apparatus may be configured to control a length of the loop antenna. If the RFID apparatus is applied to small-sized mobile terminals, reducing an antenna-occupied area may be possible via controlling of the antenna length.

Although example embodiments have been described to include the RFID schemes described above, the examples are only used for illustrative purposes. One of ordinary skill in the art will understand that variations including additional RFID schemes and apparatus including more than the described RFID schemes described above is within the scope of this disclosure.

The RFID apparatus may include mobile terminals such as cellular phone, PDA, PMP, and the like and support a plurality of RFID manners by switching one loop antenna into a chip corresponding to each RFID manner.

The above-disclosed subject matter is to be considered illustrative, and not restrictive, and the appended claims are intended to cover all such modifications, enhancements, and other embodiments, which fall within the true spirit and scope. Thus, to the maximum extent allowed by law, the scope is to be determined by the broadest permissible interpretation of the following claims and their equivalents, and shall not be restricted or limited by the foregoing detailed description.

While example embodiments have been particularly shown and described, it will be understood by one of ordinary skill in the art that variations in form and detail may be made therein without departing from the spirit and scope of the claims.

What is claimed is:

1. A radio frequency identification (RFID) apparatus comprising:
a first RFID chip configured to control data communication using a first RFID scheme;
a second RFID chip configured to control data communication using a second RFID scheme;
a loop antenna having first antenna connection terminals for a first length and second antenna connection terminals for a second length;
a switch circuit connected with the first and second antenna connection terminals of the loop antenna, the first RFID chip and the second RFID chip; and
a controller configured to control the switch circuit so as to selectively switch the loop antenna into one of the first RFID chip and the second RFID chip based on whether data communication is one of the first and second RFID schemes.

2. The RFID apparatus of claim 1, wherein the controller is configured to,
control the switch circuit so that the first RFID chip and the first antenna connection terminals are selected if the data communication uses the first RFID scheme; and
control the switch circuit so that the second RFID chip and the second antenna connection terminals are selected if the data communication uses the second RFID scheme.

3. The RFID apparatus of claim 1, wherein the first RFID scheme is a Near Field Communication (NFC) scheme and the second RFID scheme is a mobile RFID (mRFID) scheme.

4. The RFID apparatus of claim 1, wherein the first RFID chip, the second RFID chip, and the switch circuit are implemented in a single chip.

5. The RFID apparatus of claim 1, wherein the first length is longer than the second length.

6. The RFID apparatus of claim 1, wherein when the first length is identical to the second length, a length of the loop antenna is determined to support both the first RFID scheme and the second RFID scheme.

7. The RFID apparatus of claim 1, wherein the first RFID chip includes a capacitor having a capacitance value which is determined based on a resonance made according to an inductance value of the loop antenna at a frequency band of the first RFID chip.

8. The RFID apparatus of claim 1, wherein the loop antenna is one of a single turn loop antenna and a multi turn loop antenna.

9. The RFID apparatus of claim 1, wherein the controller is configured to control the switch circuit in response to a select signal provided from a user.

10. The RFID apparatus of claim 9, wherein the controller controls the switch circuit such that the loop antenna is initially connected to one of the first and second RFID chips when no select signal is provided.

11. The RFID apparatus of claim 1, wherein the RFID apparatus is a mobile terminal.

12. A radio frequency identification (RFID) apparatus comprising:
two or more RFID chips configured to control data communication using two or more RFID schemes;
an antenna having two or more antenna connection terminals and having two or more loop lengths;
a switch configured to switch the two or more RFID chips between the two or more antenna connection terminals; and
a controller configured to,
determine a selected RFID scheme, and
control the switch based on the selected RFID scheme.

13. The RFID apparatus of claim 12, wherein the two or more RFID schemes is at least one of a Near Field Communication (NFC) scheme a mobile RFID (mRFID) scheme.

14. The RFID apparatus of claim 12, wherein the antenna is one of a single turn loop antenna and a multi turn loop antenna.

15. The RFID apparatus of claim 14, wherein the single turn loop antenna supports the two or more RFID schemes.

16. The RFID apparatus of claim 14, wherein the multi turn loop antenna includes loops of differing lengths, each of the loops of differing lengths supporting a different RFID scheme.

17. The RFID apparatus of claim 12, wherein the RFID chips each include a capacitor having a capacitance value which is determined based on a resonance made according to an inductance value of the antenna at a frequency band of the RFID chips.

18. A method for operating a radio frequency identification (RFID) device with two or more RFID chips, the method comprising:
determining if a select signal has been detected;
determining if the select signal selects a first RFID scheme if the select signal has been detected;
switching an antenna, having first antenna connection terminals for a first length and second antenna connection terminals for a second length, such that the first antenna connection terminals and a first RFID chip are selected if the first RFID scheme is selected, the first RFID chip configured to perform the first RFID scheme; and
switching the antenna such that the second antenna connection terminals and a second RFID chip of the RFID chips are selected to receive the data communications if the first chip is not selected, the second RFID chip configured to perform a second RFID scheme.

19. The method of claim 18, further comprising:
performing data communication using a default RFID chip of the RFID chips if the select signal has not been detected;

20. The method of claim 19, wherein the default RFID chip is one of the first RFID chip and the second RFID chip.
